(19) United States
(12) Patent Application Publication
(10) Pub. No.: US 2025/0365297 A1
(43) Pub. Date: Nov. 27, 2025

(54) QUANTUM COMPUTING ELASTIC RULE ENGINE

(71) Applicant: Bank of America Corporation, Charlotte, NC (US)

(72) Inventors: Jimmy Jason McKenzie, Huntersville, NC (US); Manu Kurian, Dallas, TX (US); Sasikumar Purushothaman, Frisco, TX (US); Jabir Mahammad, Tolichowki Hyderabad (IN)

(21) Appl. No.: 18/672,169

(22) Filed: May 23, 2024

(51) Int. Cl. H04L 9/40; G06N 10/40; G06N 10/60

(52) U.S. Cl. CPC H04L 63/1425; G06N 10/40; G06N 10/60

(57) ABSTRACT

Systems, apparatus and methods for creating and enforcing real-time counter-malicious rules are provided. Methods may include monitoring, using a quantum processing unit, interactions on a network. Methods may include identifying, using the quantum processing unit, one or more fraudulent activities included in the interactions. Methods may include amalgamating, using the quantum processing unit, the fraudulent activities. Methods may include rebuilding, using the quantum processing unit, one or more fraudster rules used by one or more entities executing the one or more fraudulent activities. Methods may include building, using the quantum processing unit, one or more elastic counteractive rules, said elastic counteractive rules counteracting the one or more fraudster rules. Methods may include executing, using the quantum processing unit, the elastic counteractive rules within the network. Methods may also include halting, using the quantum processing unit, the one or more fraudulent activities within the network using the elastic counteractive rules.

### FIELD OF TECHNOLOGY

Aspects of the disclosure relate to quantum computing.

### BACKGROUND OF THE DISCLOSURE

At times, entities use predetermined, hard-coded rules to identify people of malicious intent acting on a network. These rules are designed to recognize fraudulent activities and identify the entities that conduct the fraudulent activities. Fraudulent activities conducted by people of malicious intent may be adapted to use the latest technologies and algorithms. Therefore, many times, the predetermined, hard-coded, and relatively-slowly-changed changed, rules may fail to capture the most recent modes of fraudulent activities. Specifically, it may be difficult to continuously update the predetermined rules at the same speed that the people of malicious intent update the fraudulent activities.

Therefore, it would be desirable to create systems and methods that identify and rebuild, in real-time, rules used by people of malicious intent to perform fraudulent activities.

It would be further desirable to create, in real-time, a set of elastic rules that counteract the rules executed by fraudsters (i.e., rules that define processes executed by people of malicious intent).

It would be yet further desirable to adjust the set of elastic rules based on the continuously-monitored fraudulent activities. It would be further desirable to utilize a quantum processing unit to perform such systems and methods.

### SUMMARY OF THE DISCLOSURE

Systems, apparatus and methods for creating and enforcing real-time counter-malicious rules are provided. Systems, apparatus and methods may use artificial intelligence and/or machine learning to perform one or more operations.

Methods may include monitoring interactions on a network. A quantum processing unit may execute the monitoring.

Methods may include identifying one or more fraudulent activities included in the interactions. The quantum processing unit may execute the identifying.

Methods may include amalgamating the one or more fraudulent activities. The quantum processing unit may execute the amalgamating.

Methods may include rebuilding one or more fraudster rules. The fraudster rules may be used by one or more entities operating or executing the one or more fraudulent activities. The quantum processing unit may execute the rebuilding. The quantum processing unit may use artificial intelligence and/or machine learning to rebuild the fraudster rules.

Methods may include building one or more elastic counteractive rules. The one or more elastic counteractive rules may counteract the one or more fraudster rules. The quantum processing unit may execute the building.

Methods may include executing the elastic counteractive rules within the network. The quantum processing unit may execute the elastic counteractive rules.

Methods may include halting the one or more fraudulent activities within the network using the elastic counteractive rules. The quantum processing unit may execute the halting.

Methods may include monitoring additional interactions on the network. The quantum processing unit may execute the monitoring.

Methods may include identifying one or more additional fraudulent activities. The quantum processing unit may execute the identifying.

Methods may include amalgamating the one or more additional fraudulent activities. The quantum processing unit may execute the amalgamating.

Methods may include modifying the one or more fraudster rules based on the additional fraudulent activities. The quantum processing unit may execute the modifying.

Methods may include modifying the one or more elastic counteractive rules based on the modifying the one or more fraudster rules. The quantum processing unit may execute the modifying.

Methods may include executing the modified one or more elastic counteractive rules. The quantum processing unit may execute the modified elastic counteractive rules within the network.

At times, the elastic counteractive rules may be customized for each network node associated with, or included in, the network. As such, modifying the elastic counteractive rules may be executed individually for each network node.

At times, the network may be associated with, and/or be maintained by, an entity. Also, each network node may correspond to a customer of the entity.

In some embodiments, the elastic counteractive rules may be customized for each network node based on one or more parameters and/or characteristics of the network node. Examples of parameters and/or characteristics may include a location of the network node, a size of the network node, a number of requests that were received at the network from the network node, a latency associated with the network node when responding to requests, one or more nodes with which the network nodes interacts on a regular basis, processing capabilities of the network node, one or more hardware and/or software components associated with the network node and any other suitable parameters and/or characteristics. Examples of parameters and/or characteristics may also include behavioral characteristics of the network node (for example, tone of voice associated with the network node, communication speed associated with the network node and pitch associated with the network node).

In certain embodiments, the elastic counteractive rules may include a first rule. The first rule may use a predetermined amount of data to complete execution of the first rule. In order to execute, the first rule may receive a first amount of data. However, the first amount of data may be insufficient to complete execution of the first rule. As such, the quantum processing unit may scan the network for a second amount of data. The second amount of data may be combined with the first amount of data. The second amount of data combined with the first amount of data may be sufficient to complete execution of the first rule. The quantum processing unit may retrieve the second amount of data from the network. The quantum processing unit may execute the first rule. The first rule may be executed using both the first amount of data and the second amount of data. As such, the elastic rules may be continuously adjusting themselves based on the current network conditions.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative diagram in accordance with principles of the disclosure;

FIG. 2 shows another illustrative diagram in accordance with principles of the disclosure;

FIG. 3 shows yet another illustrative diagram in accordance with principles of the disclosure;

FIG. 4 shows an illustrative flow diagram in accordance with principles of the disclosure;

FIG. 5 shows another illustrative flow diagram in accordance with principles of the disclosure;

FIG. 6 shows an illustrative diagram in accordance with principles of the disclosure; and

FIG. 7 shows another illustrative diagram in accordance with principles of the disclosure.

### DETAILED DESCRIPTION OF THE DISCLOSURE

Apparatus, methods, systems for a quantum network is provided.

A quantum network system may detect and prevent malicious activities in real-time. The quantum network system may include a quantum processing unit. The quantum processing unit may monitor interactions on a network. The quantum processing unit may identify one or more fraudulent activities included in the interactions. The quantum processing unit may amalgamate the one or more fraudulent activities. The quantum processing unit may rebuild one or more fraudster rules used by one or more entities executing the one or more fraudulent activities. The quantum processing unit may build one or more elastic counteractive rules. The elastic counteractive rules may counteract the fraudster rules. The quantum processing unit may execute the elastic counteractive rules within the network. The quantum processing unit may halt the one or more fraudulent activities within the network using the elastic counteractive rules.

The quantum processing unit may monitor additional interactions on the network. The quantum processing unit may identify one or more additional fraudulent activities based on the additional interactions on the network. The quantum processing unit may amalgamate the one or more additional fraudulent activities. The quantum processing unit may modify the one or more fraudster rules based on the additional fraudulent activities. The quantum processing unit may modify the one or more elastic counteractive rules based on the modifying the one or more fraudster rules. The quantum processing unit may execute the modified one or more elastic counteractive rules.

The elastic counteractive rules may be customized for each network node, associated with, or included in, the network. The elastic counteractive rules may be customized for each network node based on one or more parameters and/or one or more characteristics of the network node. For example, the elastic counteractive rules may consider the location of the network node, the processor type of the network node and any other suitable parameters and/or characteristics.

At times, the network may be an entity. Each network node may correspond to a customer of the entity.

The quantum processing unit may be operable to execute a set of permanent rules within the network. The set of permanent rules may override the elastic counteractive rules.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

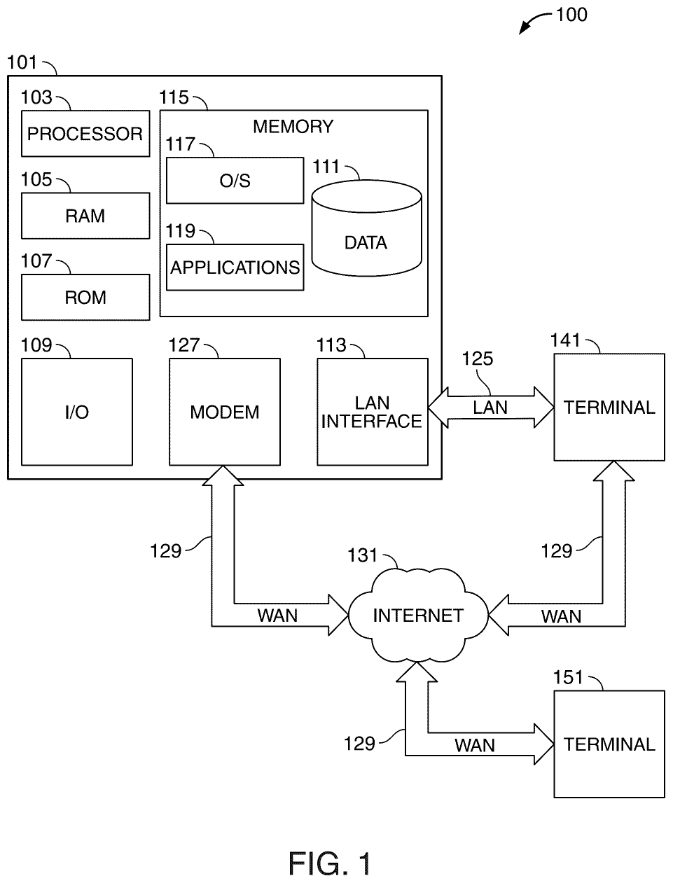

FIG. 1 shows an illustrative block diagram of system 100 that includes computer 101. Computer 101 may alternatively be referred to herein as an “engine,” “server” or a “computing device.” Computer 101 may be a workstation, desktop, laptop, tablet, smart phone, or any other suitable computing device. Elements of system 100, including computer 101, may be used to implement various aspects of the systems and methods disclosed herein. Each of the user telephones, mobile devices, user devices, databases and any other part of the disclosure may include some or all of apparatus included in system 100.

Computer 101 may have a processor 103 for controlling the operation of the device and its associated components and may include Random Access Memory (“RAM”) 105, Read Only Memory (“ROM”) 107, input/output circuit 109 and a non-transitory or non-volatile memory 115. Machine-readable memory may be configured to store information in machine-readable data structures. The processor 103 may also execute all software executing on the computer—e.g., the operating system and/or voice recognition software. Other components commonly used for computers, such as EEPROM or Flash memory or any other suitable components, may also be part of the computer 101.

Memory 115 may be comprised of any suitable permanent storage technology—e.g., a hard drive. Memory 115 may store software including the operating system 117 and application(s) 119 along with any data 111 needed for the operation of the system 100. Memory 115 may also store videos, text and/or audio assistance files. Nodes, servers, computing devices, user telephones, user devices, databases and any other suitable computing devices as disclosed herein may have one or more features in common with Memory 115. The data stored in Memory 115 may also be stored in cache memory, or any other suitable memory.

Input/output (“I/O”) module 109 may include connectivity to a microphone, keyboard, touch screen, mouse and/or stylus through which input may be provided into computer 101. The input may include input relating to cursor movement. The input/output module may also include one or more speakers for providing audio output and a video display device for providing textual, audio, audiovisual and/or graphical output. The input and output may be related to computer application functionality.

System 100 may be connected to other systems via a local area network (“LAN”) interface 113. System 100 may operate in a networked environment supporting connections to one or more remote computers, such as terminals 141 and 151. Terminals 141 and 151 may be personal computers or servers that include many or all of the elements described above relative to system 100. When used in a LAN networking environment, computer 101 is connected to LAN 125 through a LAN interface or adapter 113. When used in a Wide Area Network (“WAN”) networking environment, computer 101 may include a modem 127 or other means for establishing communications over WAN 129, such as Internet 131. Connections between System 100 and Terminals 151 and/or 141 may be used for the communication between different nodes and systems within the disclosure.

It will be appreciated if the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (“API”). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may be configured to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (“SMS”) and voice input and speech recognition applications. Application program(s) 119 (which may be alternatively referred to herein as “plugins,” “applications,” or “apps”) may include computer executable instructions for invoking functionality related to performing various tasks. Application programs 119 may utilize one or more algorithms that process received executable instructions, perform power management routines or other suitable tasks. Application programs 119 may utilize one or more decisioning processes.

Application program(s) 119 may include computer executable instructions (alternatively referred to as “programs”). The computer executable instructions may be embodied in hardware or firmware (not shown). Computer 101 may execute the instructions embodied by the application program(s) 119 to perform various functions.

Application program(s) 119 may utilize the computer-executable instructions executed by a processor. Generally, programs include routines, programs, objects, components, data structures, etc. that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage and process data (e.g., “cloud computing” and/or “fog computing”).

Any information described above in connection with data 111 and any other suitable information, may be stored in memory 115. One or more of applications 119 may include one or more algorithms that may be used to implement features of the disclosure comprising the transmission, storage, and transmitting of data and/or any other tasks described herein.

The invention may be described in the context of computer-executable instructions, such as applications 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered for the purposes of this application, as engines with respect to the performance of the particular tasks to which the programs are assigned.

Computer 101 and/or terminals 141 and 151 may also include various other components, such as a battery, speaker and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 151 and/or terminal 141 may be portable devices such as a laptop, cell phone, tablet, smartphone, or any other computing system for receiving, storing, transmitting and/or displaying relevant information. Terminal 151 and/or terminal 141 may be one or more data sources or a calling source. Terminals 151 and 141 may have one or more features in common with apparatus 101. Terminals 115 and 141 may be identical to system 100 or different. The differences may be related to hardware components and/or software components.

The invention may be operational with numerous other general purpose or special purpose computing system environments or configurations. Examples of well-known computing systems, environments and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices and the like.

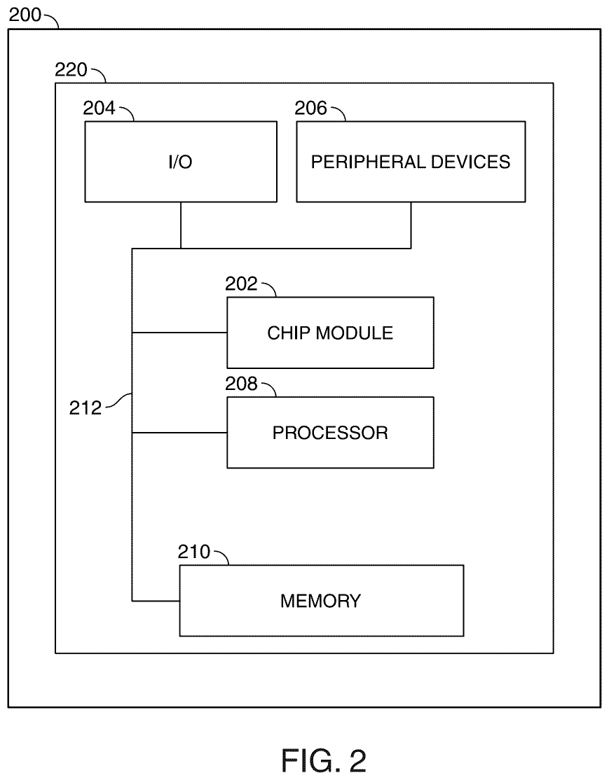

FIG. 2 shows illustrative apparatus 200 that may be configured in accordance with the principles of the disclosure. Apparatus 200 may be a computing device. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 119, signals and/or any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

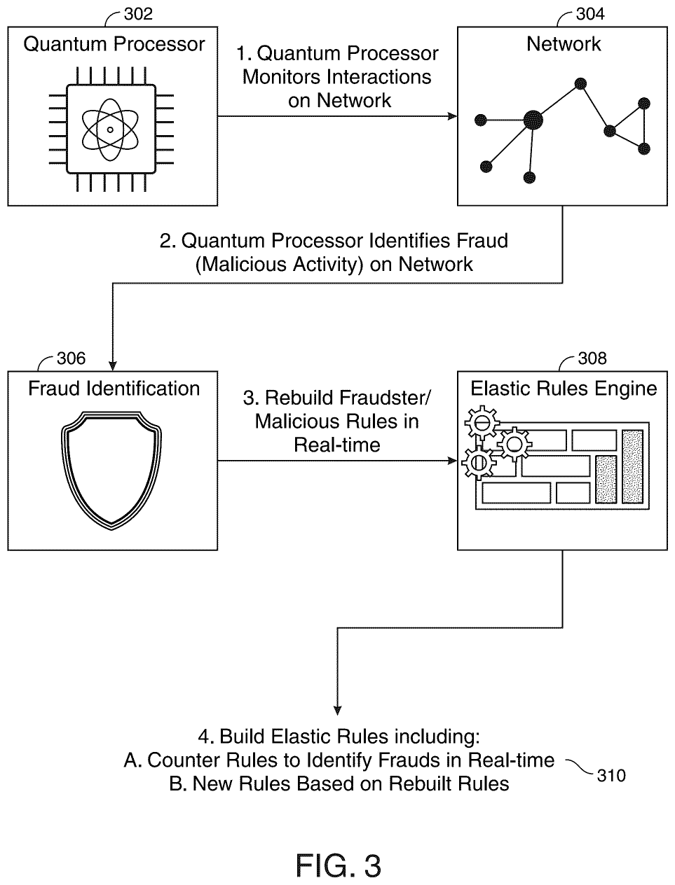

FIG. 3 shows an illustrative diagram. Quantum processor 302 may monitor interactions on network 304. Network 304 may include a plurality of nodes. Each node may be a computing device. Each node may interact with, and/or communicate with, other nodes on the network. As such, each node may transmit data to, and/or receive data from, one or more other nodes. The interactions between nodes may be monitored by the quantum processor.

The network may be an open network. As such, nodes may join the open network without prior approval.

The network may be a closed network. As such, nodes may request approval prior to joining the closed network.

The interactions may be logged by quantum processor 302. Quantum processor 302, using the capabilities of quantum processing, may process large amounts of data in relatively short time periods. As such, quantum processor 302 may identify fraud (malicious activity), shown at 306, on the network.

The malicious activity may have been included in the logged interactions. The malicious activity may be identified by identifying transactions that fail to match, or, alternatively, that correspond to, a predetermined pattern. The predetermined pattern may be an authorized activity pattern. The authorized activity pattern may be specific to a user, specific to a group of users and/or specific to substantially all users. The authorized activity pattern may be based on one or more parameters and/or characteristics of the user of the network node, the group of users associated with a group of network nodes or substantially all users associated with substantially all network nodes.

Examples of parameters and/or characteristics may include a location of the network node, a size of the network node, a number of requests that were received at the network from the network node, a latency associated with the network node when responding to requests, one or more nodes with which the network nodes interacts on a regular basis, processing capabilities of the network node, one or more hardware and/or software components associated with the network node and any other suitable parameters and/or characteristics. Examples of parameters and/or characteristics may also include behavioral characteristics of the network node (for example, tone of voice associated with the network node, communication speed associated with the network node and pitch associated with the network node).

An example of identifying malicious activity or transactions because such activity or transactions fail to match a predetermined pattern follows. Interactions and/or transactions may typically follow one or more patterns. The pattern may be specific to a user. The pattern may be specific to a group of users. The pattern may be specific to substantially all users. However, fraudulent interactions and/or transactions may lack one or more process steps included in the patterns. An example of a transaction that may be fraudulent because it lacks one or more process steps is a credit card transaction that lacks the token associated with a chip input. Another example of a transaction that may be fraudulent because it lacks one or more process steps may be a mortgage application that lacks an associated valid mobile or home telephone number. In such circumstances, quantum processor 302 may label the interactions lacking one or more process steps as a fraudulent transaction. At times, quantum processor 302 may characterize interactions lacking one or more process steps with greater than a threshold of probability of being a fraudulent transaction.

The malicious activity may be fraudulent payment card transactions, fraudulent mortgage qualification, fraudulent obtainment of identification (such as, for example, a passport, travel document or license), or any other suitable malicious activity.

Once one or more malicious activities have been identified, the quantum processor may identify rules used to execute the malicious activity. Such rules may be referred to as fraudster or malicious rules. Examples of fraudster/malicious rules may include retrieving payment card data from fitness membership sites. The retrieved payment card data may then be used to process a fraudulent fitness membership fee each month.

Elastic rules engine 308 may use the rebuilt fraudster/malicious rules to generate elastic rules, as shown at 310. The elastic rules may include counter rules. The counter rules may be able to identify frauds in real-time. For example, the fraudster/malicious rules may include fraudulently processing fitness membership fees. As such, the elastic rules may include identifying fitness membership fees during processing and requesting an additional factor of authentication, from the payment card holder. The additional factor of authentication may be a response to a short messaging service (“SMS”), email, push notification or any other suitable additional factor of authentication.

Elastic rules engine 308 may also build new rules. The new rules may be based on the rebuilt rules. The new rules may be based in part on the rebuilt rules. An example of the new rules may include forcing chip card payments at certain establishments, such as fitness clubs.

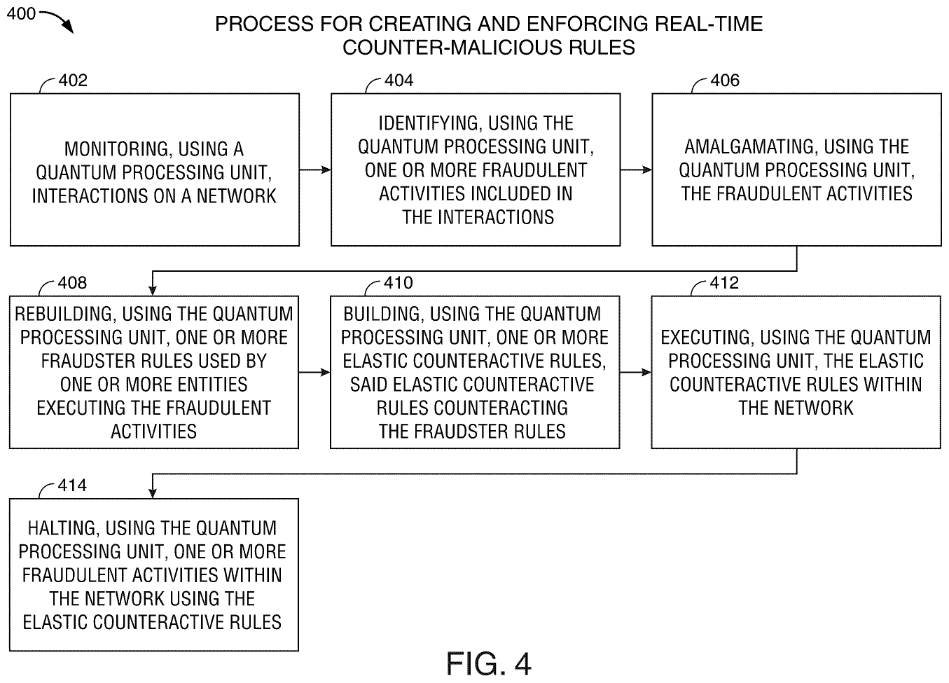

FIG. 4 shows an illustrative flow chart. The illustrative flow chart is shown at 400. Step 402 shows monitoring, using a quantum processing unit, interactions on a network. The interactions may be included in a log.

Step 404 shows identifying, using the quantum processing unit, one or more fraudulent activities included in the interactions. The identifying may include perusing the log for interactions that match a predetermined fraud threshold. Interactions that match the predetermined fraud threshold may include interactions identified by a user as fraudulent. For example, a payment card holder may notify an entity that a particular payment was not authorized by the payment card holder. In response to receiving the notification from the payment card holder (or user) that the particular payment was unauthorized, the entity may label the interaction in which the unauthorized user processed the particular payment as an unauthorized or fraudulent activity.

Step 406 shows amalgamating, using the quantum processing unit, the fraudulent activities. The quantum processing unit may group the fraudulent activities into a grouping of activities. For example, the quantum processing unit may create a log of the fraudulent activities. In another example, the quantum processing unit may create a list of the fraudulent activities. In yet another example, the quantum processing unit may create an object for each of the fraudulent activities. The quantum processing unit may link the objects to create a grouping of activities.

Step 408 shows rebuilding, using the quantum processing unit, one or more fraudster rules used by one or more entities executing the fraudulent activities. The fraudster rules may identify one or more processes in which a fraudulent entity performs a fraudulent activity. For example, a fraudster rule may be a condition associated with a transaction. When the condition is fulfilled, the fraudulent entity may have maliciously duplicated or maliciously recreated the transaction. The fraudster rules may include one or more parameters and one or more outputs. Examples of parameters of the fraudster rules may include dollar amounts, date and time parameters, internet protocol (“IP”) address ranges, computer hardware specifications and any other suitable parameters. Examples of outputs of the fraudster rules may be transactions labeled fraudulent, spam, unauthorized or any other suitable labeled transaction. As such, a fraudster rule may be identified as one or more parameters, which cause one or more outputs.

Step 410 shows building, using the quantum processing unit, one or more elastic counteractive rules. The one or more elastic counteractive rules may be generated to counteract the effect of the fraudster rule. As such, the elastic counteractive rule may identify transactions as fraudulent. The identification may be based on a comparison between the transaction and the fraudster rule. The selected transactions may be labeled as fraudulent during processing and may be prevented from being processed.

Step 412 shows executing, using the quantum processing unit, the elastic counteractive rules within the network. The elastic counteractive rules within the network may be operable to identify one or more fraudulent activities within the network.

Step 414 shows halting, using the quantum processing unit, one or more fraudulent activities within the network using the elastic counteractive rules. The identified one or more fraudulent activities may be halted using the quantum processing unit. As such, the fraudulent activities, such as fraudulent transactions may be halted prior to being processed. Therefore, computing bandwidth may be saved at least because fraudulent transactions are not processed. Processed fraudulent transactions may drain resources from an entity and/or user. At times, the resources may be temporarily withdrawn from the entity or the user, or the resources may be permanently consumed from the entity or the user.

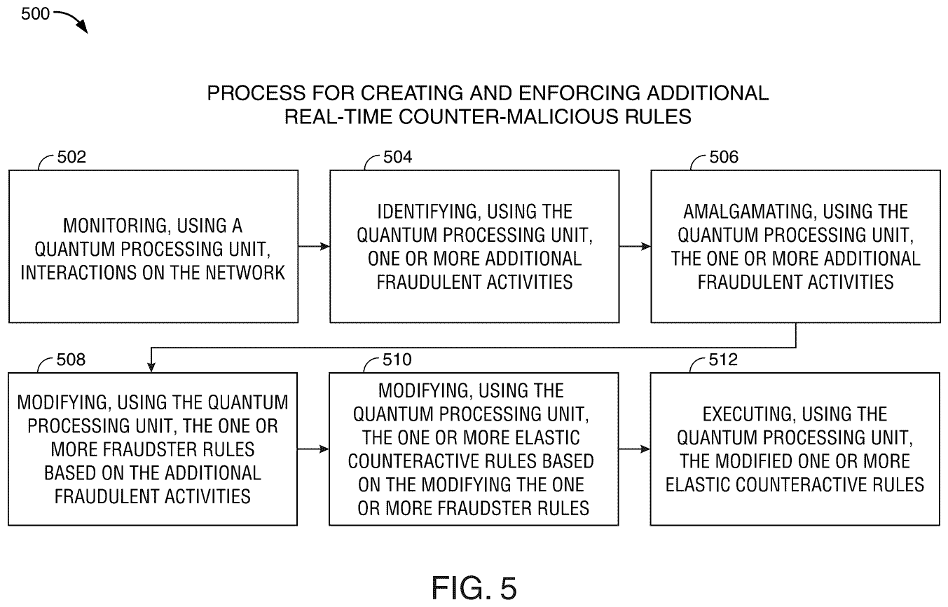

FIG. 5 shows an illustrative flow chart. The illustrative flow chart is shown at 500. The illustrative flow chart shows the process for creating and enforcing additional real-time counter-malicious rules.

Step 502 shows monitoring, using the quantum processing unit, interactions on the network. The quantum processing unit may monitor the network for additional interactions. The interactions may have been executed after the elastic counteractive rules have been instantiated. As such, these interactions may be labeled as additional interactions. It should be noted that because the elastic counteractive rules are dynamic, interactions may be continuously monitored and the elastic counteractive rules may be continuously modified.

Step 504 shows identifying, using the quantum processing unit, one or more additional fraudulent activities. Step 506 shows amalgamating, using the quantum processing unit, the one or more additional fraudulent activities. At times, the one or more additional fraudulent activities may be appended to an operating list of fraudulent activities. Other times, the one or more additional fraudulent activities may be included in an additional list of fraudulent activities.

Step 508 shows modifying, using the quantum processing unit, the one or more fraudster rules based on the additional fraudulent activities. At times, modifying the additional fraudulent activities may include modifying an operating list of fraudulent activities.

Step 510 shows modifying, using the quantum processing unit, the one or more elastic counteractive rules. The one or more elastic counteractive rules may be modified based on the modifying the one or more fraudster rules. Modifying the one or more elastic counteractive rules may include modifying an operating list of elastic counteractive rules.

Step 512 shows executing, using the quantum processing unit, the modified one or more elastic counteractive rules. The modified elastic counteractive rules may be executed within the network.

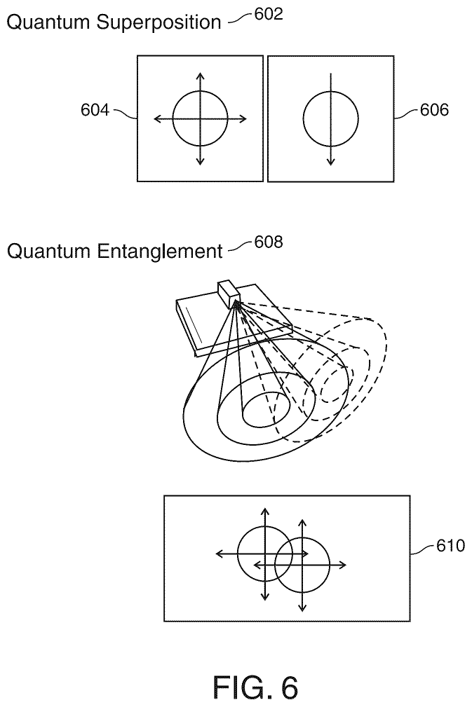

FIG. 6 shows an illustrative diagram. The illustrative diagram shows components of quantum technology. Because quantum technology behaves differently from classical technology, quantum technology provides additional facets to computing. While storage and computing capacity of classical computing grows in a linear fashion, storage and computing capacity of quantum computing grows in an exponential fashion.

Quantum technology may rely on properties of quantum mechanics, such as, for example, quantum superposition, quantum entanglement, quantum tunnelling and quantum interference.

Quantum superposition, shown at 602, states that an unobserved quantum particle, such as a photon, exists in all possible states (spin-up state, a spin-down state or any probability of a spin-up state and spin-down state) simultaneously, as shown at 604. However, when a quantum particle is observed or measured, the quantum particle collapses into a single state, such as a spin-down state, as shown at 606.

Quantum entanglement, shown at 308, states that quantum particles may become connected with one another. The entangled particles correlate with each other, as shown at 610. As such, even when the entangled particles are physically far apart, measuring the state of one of the entangled particles reveals the state of the other entangled particle.

A laser beam fired through a certain type of crystal can cause individual photons to be split into pairs of entangled photons. A pair of entangled photons may be shown at 608.

Quantum tunnelling states that a quantum particle may pass through a potential energy barrier that, according to classical physics, should not be passable due to the object not having sufficient energy to pass or surmount the barrier.

Quantum interference states that a quantum particle may interface with and/or influence itself and/or other particles while in a superposition state. Quantum interference can influence the probability of the state of the particle when the quantum particle is measured.

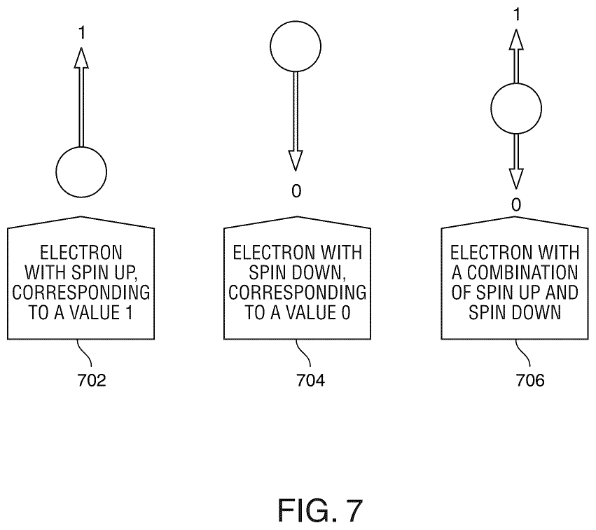

FIG. 7 shows an illustrative diagram. The illustrative diagram shows multiple electrons. A first electron, shown at 702, shows a spin-up, which may correspond, within a quantum processor, to a value of one. A second electron, shown at 704, shows a spin-down, which may correspond, within a quantum processor, to a value of zero. A third electron, shown at 706, shows a combination of a spin-up and a spin-down, which may correspond, within a quantum processor, to a value of both one and zero. A combination state of both spin-up and spin-down may be referred to as superposition.

Thus, systems and methods for a quantum computing elastic rule engine are provided. Persons skilled in the art will appreciate that the present invention can be practiced by other than the described embodiments, which are presented for purposes of illustration rather than of limitation. The present invention is limited only by the claims that follow.

What is claimed is:

1. A quantum network system that detects and prevents malicious activities in real-time, the quantum network system comprising:
a quantum processing unit operable to:
monitor interactions on a network;
identify one or more fraudulent activities included in the interactions, said fraudulent activities failing to correspond with an authorized activity pattern;
amalgamate the one or more fraudulent activities into a log of fraudulent activities;
rebuild, using artificial intelligence, based on the log of fraudulent activities, one or more fraudster rules used by one or more entities executing the one or more fraudulent activities;
build one or more elastic counteractive rules, said elastic counteractive rules counteracting the fraudster rules, said elastic counteractive rules comprising a first rule, said first rule using a predetermined amount of data to complete execution of the first rule;
execute the elastic counteractive rules within the network, wherein when the first rule receives a first amount of data to complete execution of the first rule:
the first rule identifies the first amount of data as insufficient to complete execution of the first rule;
the quantum processing unit scans the network for a second amount of data, the second amount of data combined with the first amount of data being sufficient to complete execution of the first rule;
the quantum processing unit retrieves the second amount of data from the network; and
the quantum processing unit provides the second amount of data to the first rule;
halt the one or more fraudulent activities within the network using the elastic counteractive rules.

2. The quantum network system of claim 1 wherein the elastic counteractive rules are customized for each network node associated with the network.

3. The quantum network system of claim 2 wherein the elastic counteractive rules are customized for each network node based on one or more characteristics of the network node.

4. The quantum network system of claim 3 wherein the authorized activity pattern is customized for each network node based on the one or more characteristics of the network node.

5. A method for creating and enforcing real-time counter-malicious rules, the method comprising:
monitoring, using a quantum processing unit, interactions on a network;
identifying, using the quantum processing unit, one or more fraudulent activities included in the interactions;
amalgamating, using the quantum processing unit, the one or more fraudulent activities;
rebuilding, using the quantum processing unit, one or more fraudster rules used by one or more entities executing the one or more fraudulent activities;
building, using the quantum processing unit, one or more elastic counteractive rules, said elastic counteractive rules counteracting the one or more fraudster rules;
executing, using the quantum processing unit, the elastic counteractive rules within the network; and
halting, using the quantum processing unit, the one or more fraudulent activities within the network using the elastic counteractive rules.

6. The method of claim 5 further comprising:
monitoring, using the quantum processing unit, additional interactions on the network;
identifying, using the quantum processing unit, one or more additional fraudulent activities;
amalgamating, using the quantum processing unit, the one or more additional fraudulent activities;
modifying, using the quantum processing unit, the one or more fraudster rules based on the additional fraudulent activities;
modifying, using the quantum processing unit, the one or more elastic counteractive rules based on the modifying the one or more fraudster rules; and
executing, using the quantum processing unit, the modified one or more elastic counteractive rules.

7. The method of claim 5 wherein the elastic counteractive rules are customized for each network node associated with the network.

8. The method of claim 7 wherein:
the network is associated with an entity; and
each network node corresponds to a customer of the entity.

9. The method of claim 7 wherein the elastic counteractive rules are customized for each network node based on a location of the network node.

10. The method of claim 5 further comprising executing a set of permanent rules within the network, said set of permanent rules which override the elastic counteractive rules.

11. The method of claim 7 wherein the elastic counteractive rules are customized for each network node based on one or more characteristics of the network node.

12. The method of claim 5 wherein the elastic counteractive rules include a first rule, said first rule using a predetermined amount of data to complete execution of the first rule, said first rule receiving a first amount of data, said first amount of data being insufficient to complete execution of the first rule, the method further comprising:
scanning, using the quantum processing unit, the network for a second amount of data, said second amount of data combined with the first amount of data being sufficient to complete execution of the first rule;
retrieving, using the quantum processing unit, the second amount of data from the network; and
executing, using the quantum processing unit, the first rule.

13. A quantum network system that detects and prevents malicious activities in real-time, the quantum network system comprising:
a quantum processing unit operable to:
monitor interactions on a network;
identify one or more fraudulent activities included in the interactions;
amalgamate the one or more fraudulent activities;
rebuild one or more fraudster rules used by one or more entities executing the one or more fraudulent activities;
build one or more elastic counteractive rules, said elastic counteractive rules counteracting the fraudster rules;
execute the elastic counteractive rules within the network; and
halt the one or more fraudulent activities within the network using the elastic counteractive rules.

14. The quantum network system of claim 13 wherein the quantum processing unit is further operable to:
monitor additional interactions on the network;
identify one or more additional fraudulent activities based on the additional interactions on the network;
amalgamate the one or more additional fraudulent activities;
modify the one or more fraudster rules based on the additional fraudulent activities;
modify the one or more elastic counteractive rules based on the modifying the one or more fraudster rules; and
execute the modified one or more elastic counteractive rules.

15. The quantum network system of claim 13 wherein the elastic counteractive rules are customized for each network node associated with the network.

16. The quantum network system of claim 13 wherein:
the network is associated with an entity; and
each network node corresponds to a customer of the entity.

17. The quantum network system of claim 15 wherein the elastic counteractive rules are customized for each network node based on a location of the network node.

18. The quantum network system of claim 13 wherein the quantum processing unit is further operable to execute a set of permanent rules within the network, the set of permanent rules which override the elastic counteractive rules.

19. The quantum network system of claim 15 wherein the elastic counteractive rules are customized for each network node based on one or more characteristics of the network node.

20. The quantum network system of claim 13 wherein the elastic counteractive rules include a first rule, said first rule using a predetermined amount of data to complete execution of the first rule, said first rule receiving a first amount of data, said first amount of data being insufficient to complete execution of the first rule, the quantum processing unit further operable to:
scan the network for a second amount of data, said second amount of data combined with the first amount of data being sufficient to complete execution of the first rule;
retrieve the second amount of data from the network; and
execute the first rule.
